(19) United States
(12) Patent Application Publication
(10) Pub. No.: US 2025/0075717 A1
(43) Pub. Date: Mar. 6, 2025

(54) SILL LEVELING DEVICE

(71) Applicant: GOLDBRECHT LLC, Paramount, CA (US)

(72) Inventor: Thomas KERN, Paramount, CA (US)

(73) Assignee: GOLDBRECHT LLC, Paramount, CA (US)

(21) Appl. No.: 18/240,740

(22) Filed: Aug. 31, 2023

(51) Int. Cl. F16B 5/02; E06B 1/60

(52) U.S. Cl. CPC F16B 5/0233; E06B 1/6076

(57) ABSTRACT

A thermally broken sill leveling device securing a door or window frame member to a substructure, including: an adjuster plate having a female threaded through hole therein and configured to be secured to the frame member; an adjustment screw for threadedly engaging the female threaded hole of the adjuster plate, the adjustment screw having a through hole therein; and a locking screw for securing the adjuster plate to the substructure, the locking screw passing through the through hole of the adjustment screw and being screwed to the substructure, wherein a spacing between the frame member and the substructure is adjusted by rotatably adjusting the adjustment screw so that a distal end thereof abuts against the substructure. This adjusts the space between the frame member and the substructure.

### BACKGROUND OF THE INVENTION

The invention relates to a thermally broken sill leveling device for adjustably leveling a door frame or window frame to a threshold.

Conventionally, door frames and window frames are secured to a threshold using screws and are leveled using shims. There are many disadvantages with this approach.

### SUMMARY OF THE INVENTION

A sill leveling device securing a door or window frame member to a substructure, comprising: an adjuster plate having a female threaded through hole therein and configured to be secured to the frame member; an adjustment screw for threadedly engaging the female threaded hole of the adjuster plate, the adjustment screw having a through hole therein; and a locking screw for securing the adjuster plate to the substructure, the locking screw passing through the through hole of the adjustment screw and being screwed to the substructure, wherein a spacing between the frame member and the substructure is adjusted by rotatably adjusting the adjustment screw so that a distal end thereof abuts against the substructure. This adjusts the space between the frame member and the substructure. Sill leveling devices are provided intermittently along the length of the frame member to allow adjustment of the height between the frame member and the substructure along the length of the frame member.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a perspective view of the sill leveling device;

FIG. 2 is a cross-sectional view of the sill leveling device;

FIG. 3 is a perspective view of the sill leveling device according to another embodiment;

FIG. 4 is a cross-sectional view of the sill leveling device of FIG. 3;

FIG. 5 is a perspective view of the sill leveling device in a single track arrangement; and

FIG. 6 is a perspective view of the sill leveling device in a multi-track arrangement.

### DETAILED DESCRIPTION OF THE INVENTION

The following detailed description of example implementations refers to the accompanying drawings. The same reference numbers in different drawings may identify the same or similar elements.

FIGS. 1 and 2 illustrate the sill leveling device 10 according to an embodiment for securing a window or door frame member 12 to a substructure 14.

The sill leveling device 10 includes an adjuster plate 16, an adjustment screw 18 and a locking screw 20 that is coaxial with the adjustment screw 18. The adjuster plate 16 is provided with a female threaded hole 22 and is configured to be fixed to the frame member 12 by screws, adhesive, press-fit, clipped or the like. The adjuster plate 16 includes a plate portion 24 and a protruding portion 26.

The adjustment screw 18 is treaded in the female threaded hole 22 of the adjuster plate 16 and has a through threaded hole 28 for receiving the locking screw 20 that secures the adjuster plate 16 to the substructure 14.

More specifically, the adjustment screw 18 is screwed into the threaded hole 22 of the adjuster plate 16 such that a bottom end of the adjustment screw 18 abuts against the substructure 14. The adjustment screw 18 is then rotated to adjust the distance between the substructure 14 and frame member 12. Once the distance has been properly set, the locking screw 20 is screwed into the through hole 28 in the adjustment screw 18 and screwed into the substructure 14 such that the frame member 12 is secured to the substructure 14 with a fixed distance therebetween. It is noted that the adjustment screw 18 has a head portion that can receive a tool to rotate the adjustment screw 18, and the locking screw 20 also has a head portion that can receive a tool to rotate the locking screw 20.

The adjuster plate 16 may be made of plastic or metal. If the adjuster plate is made of metal it is preferable to include a thermal break 30 provided between the adjuster plate 16 and the base of the frame member 12. The thermal break 30 is a plate made out of plastic or other material that provide a thermal barrier between the frame member and the metal adjuster plate.

FIGS. 3 and 24 illustrate the sill leveling device 10 according to another embodiment for securing a window or door frame member 12 to a substructure 14. In this embodiment the adjuster plate 16 includes a thicker, more rigid, plate portion 24 than the prior embodiment and does not include a protruding portion.

The sill leveling device allows for post-installation height adjustments of a door or window frame without requiring access to the underside of the frame, which is a significant advantage over traditional shimming procedures.

Additionally, the coaxial arrangement of the adjustment screw 18 and the locking screw 20 eliminates pressure points and bending moments on the frame member 12, thus reducing the likelihood of deformation to the frame member 12. By contrast, in conventional shimming procedures where shim pack and a fastening screw are offset, additional stress is applied to the frame member, which may lead to bending or warping of the frame member.

According to the invention, there may be multiple sill leveling devices 10 used for leveling and securing the door or window frame member 12 to the substructure 14. They may be placed intermittently along a length of the window or door frame member, as shown in FIG. 5, in a single track arrangement. Alternatively, the sill leveling devices 10 can be placed both along a length of the window or door frame member and laterally adjacent each other in a double, or multiple, track arrangement, as shown in FIG. 6.

The foregoing disclosure provides illustration and description, but is not intended to be exhaustive or to limit the implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A sill leveling device securing a door or window frame member to a substructure, comprising:
an adjuster plate having a female threaded through hole therein and configured to be secured to the frame member;
an adjustment screw for threadedly engaging the female threaded hole of the adjuster plate, the adjustment screw having a through hole therein; and
a locking screw for securing the adjuster plate to the substructure, the locking screw passing through the through hole of the adjustment screw and being screwed to the substructure,
wherein a spacing between the frame member and the substructure is adjusted by rotatably adjusting the adjustment screw so that a distal end thereof abuts against the substructure.

2. The sill leveling device of claim 1, wherein the female threaded hole in the adjuster plate is axially aligned with the through hole in the adjustment screw.

3. The sill leveling device of claim 1, wherein the adjuster plate includes a plate portion and a protruding portion, the protruding portion being received in the frame member.

4. The sill leveling device of claim 1, further comprising a thermal breaker disposed between the adjuster plate and the frame member.

5. A sill leveling assembly, comprising a plurality of sill leveling devices of claim 1 spaced along a length of the frame member.

6. A sill leveling assembly, comprising a plurality of sill leveling devices of claim 1 and a plurality of frame members located adjacent each other, the sill leveling devices respectively being spaced along a length of each of the plurality of frame members.
